(19) United States
(12) Patent Application Publication
(10) Pub. No.: US 2007/0101605 A1
(43) Pub. Date: May 10, 2007

(54) Door-side footwear container

(76) Inventor: Scott Susalla, Carlsbad, CA (US)

Correspondence Address: DONN K. HARMS;PATENT & TRADEMARK LAW CENTER, SUITE 100, 12702 VIA CORTINA, DEL MAR, CA, 92014, US

(21) Appl. No.: 11/270,850

(22) Filed: Nov. 8, 2005

(51) Int. Cl. F26B 25/06; F26B 19/00; F26B 25/18

(52) U.S. Cl. 34/202; 34/90; 34/192

(57) ABSTRACT

A hermetic footwear container adapted for placement at the entrance to a home or building where it is the custom to remove your footwear. In addition to footwear storage, the device has the capability of warming, drying and deodorizing the footwear during inclement weather, with the debris that normally falls off, falling into a removable insert tray. Access to the interior of the device is provided by a foot pedal cover opener or an automatic motion sensor actuating an electric motor to open the cover.

### FIELD OF THE INVENTION

The present invention relates to a decorative door-side container that can be manufactured in a variety of sizes to deposit footwear when entering a home or other building. It is the custom in many homes to remove your shoes or boots before going inside. Problems arise where footwear has become soiled or the footwear is wet and requires being left outside or dried. A cluttered pile of shoes and boots along with the debris that has fallen off at the entrance of a home is unsightly.

### BACKGROUND OF THE INVENTION

In many homes, it is customary to remove your shoes or boots before entering. Shoes and boots at the door create an unsightly appearance to the front or rear entrance of any building. It is often embarrassing for those individuals who live in a home where this is practiced to ask an unaware guest to remove their shoes. Having a small sign and an attractive container at the door keeps the home more inviting and helps people be aware of others customs. This inventor has devised as a basic unit an attractive container that will come in a variety of sizes in which to hold one or more pairs of shoes or boots with a cover that hinges back out of the way when opened, a tray that automatically extends to collect the debris, and a grate on which to set the shoes or boots. Options will include a dryer unit with a heater and fan and a compartment for deodorizing products. Another option will have an incandescent light bulb to create warmth and a transparent area in the cover for a porch light. In inclement weather shoes and boots are often soiled or wet and if left on the surface, debris will collect and the shoes, if wet, will remain that way. Moisture left in footwear either from normal sweating or from being wet will let bacteria grow, creating odors and possible foot problems and can deteriorate the footwear. The deodorizing material placed in the compartment within the device will help to alleviate the odor problem and minimize bacteria growth. Homes in the Midwest often have mudrooms at the rear entrance in which to leave soiled apparel, but it is a difficult and long process to dry shoes or boots in an open room even if it is heated and many mudrooms are not heated. It is very unpleasant to put on a cold, wet pair of shoes or boots to go out on a cold day. There are a variety of shoe and boot driers, some of which go directly into the shoes or boots, but most are attached to clothes dryers and would be unsightly and impractical at the entrance of a building. In the confined inner area of the Door-Side Footwear Container disclosed within this patent, a small amount of heat will dry the shoes or boots in a short period of time. It is always pleasant to put on a warm and dry pair of shoes when going out of doors.

This invention describes a new and unique device that has the capability of performing multiple tasks wherein it supplies a decorative hermetic container in which to place footwear before entering a house along with being able to dry and deodorize items and collect debris that has fallen off into a removable tray. A wide variety of shoe containers, shoe dryers, display and drying racks along with closet style shoe holders exist and have been patented, but there is no device available that can be placed in the external environment next to a door where the footwear will be concealed from view and dried and deodorized if necessary while being out of the weather.

### REFERENCES SITED

U.S. Pat. No. 4,908,957 (Acosta, Sr. et al.) describes an apparatus for the drying of shoes and other items utilizing the exhaust heat from a clothes drying machine. This type of apparatus, although it functions well to dry shoes and other articles, could not be used as a decorative storage container to put footwear in prior to entering a home or building. Ducting the hot air to an external location like an entry door would require a major renovation. This device was designed to be used in close proximity to a clothes dryers to make good use of the exhausted hot air.

U.S. Pat. No. 5,016,364 (Cochrane) teaches of an invention that relates to those devices having been designed to dry shoes. More specifically, Cochrane relates to shoe dryers that utilize the heat exhaust of drying machines while the drying machines are in operation to provide a separate compartment from the clothes dryer for drying the shoes. While the dryer is used to dry clothes, the heat exhaust, which would normally by vented to the outdoor environment, is directed to the compartment containing the shoes. In this way, the shoes can be dried while the clothes are drying. This patent teaches of a similar operation of drying shoes using the exhausted hot air from clothes dryers and would not be practical to be located outside one or more entrances of a home.

U.S. Pat. No. 5,165,181 (Acosta Sr. et al.) discloses another shoe dryer that utilizes the heat of a clothes drying machine to dry articles placed inside such as shoes or other articles of apparel. These dryers can only be used effectively to dry shoes when the clothes dryer is in operation. They have not been designed to be placed at the front or rear entrances of a home to temporarily store footwear prior to entering.

U.S. Pat. No. 5,412,928 (Reithel) describes a portable framework with a warm air circulating system whereby air is ducted into articles placed over duct tubes. Although this device does accomplish the task of drying and holding articles of apparel, its major intent is to dry wet turnout apparel for fire fighters and it would be unsightly at the front door of homes.

U.S. Pat. No. 5,666,743 (Dawson) tells of an apparel drying and deodorizing system where the apparel can be supported and a fan will blow air on the article. This patent has been designed to accommodate a limited number of pieces of apparel and would not be convenient placed at the front door of a home in which to temporarily place footwear when entering.

U.S. Pat. No. 6,591,517 (Moore) describes a shoe dryer and deodorizer that can be hung on the back of a door or mounted on a wall. This device could be hung at the entrance of a home, but it would be best on the inside to make the drying unit effective. Boots would not fit into the pockets of the device and debris would tend to collect in the pockets. It would not conceal the footwear nor would it be attractive no matter where it was located.

None of these previous efforts provide the benefits attendant with the present invention. The present invention achieves its intended purposes, objects and advantages over the prior art devices through a new, useful and unobvious combination of method steps and component elements with the use of a minimum number of functioning parts at a reasonable cost to manufacture and with readily available materials.

In this respect, before explaining at least one embodiment of the invention in detail it is to be understood that the invention is not limited in its application to the details of construction and to the arrangement of the components set forth in the following description or illustrated in the drawings. The invention is capable of other embodiments and of being practiced and carried out in various ways. Also it is to be understood that the phraseology and terminology employed herein are for the purpose of description and should not be regarded as limiting.

As such, those skilled in the art will appreciate that the conception upon which this disclosure is based may readily be utilized as a basis for designing of other structures, methods and systems for carrying out the several purposes of the present invention. It is important, therefore, that the claims be regarded as including such equivalent construction insofar as they do not depart from the spirit and scope of the present invention.

### SUMMARY OF THE INVENTION

The present invention relates to a new and unique device used to store shoes and boots prior to entering a home or place of business. More specifically, it supplies a hermetic location where soiled or wet footwear may be placed on a grate over a slide-out tray to catch the debris. The device in various preferred modes will have a variety of options such as an incandescent light bulb to supply warmth with a transparent window for a door night-light, a heater for drying the shoes, a deodorizing compartment, a foot pedal cover opener or an automatic motion sensor actuating an electric motor to open the cover. Optionally, in another preferred mode of the device, ventilation holes may be added to the device at various locations to remove the accumulated moisture within the container.

The basic Door-Side Footwear Container will consist of a box like structure with an access cover to open and place footwear in. A removable debris-catching insert tray with grate on top will fit into the internal tray within the container. Footwear may be placed on the grate where the debris will fall into the insert tray and air can circulate around the footwear. The insert tray can be removed from the internal tray for disposal of the collected debris. A variety of sizes and shapes of the container along with different cover arrangements and configurations for the Door-Side Footwear Container may be contemplated and will be covered within the scope of this patent.

One preferred embodiment of the device features a cover arrangement having a cover opening on a bias angle across the front of the container. The cover will hinge on a piano style of hinge on the upper horizontal edge to move up, back and out of the way of the opening into the container when inserting the footwear. The cover may have a variety of decorative shapes to enhance the product and increase the area within the container. The internal tray with the removable insert tray may be fixed within the container or it may automatically extend by the means of a fixed arm on the cover connected to a linkage arm attached to the tray clearly depicted within the attached drawings. Options yielding enhanced utility include an incandescent light bulb within the container to create light, warmth and a transparent panel formed in one or more of the top panel, the cover, or the side panels, to supply a night-light feature. A heating unit with a fan will be available along with a deodorizing compartment. Additionally, when a user approaches, the device may incorporate a means for automatic opening such as a motion sensor with a motor drive that will open and close the cover automatically. A foot pedal actuator to open the cover may also be included in combination with the means for automatic opening.

The foregoing has outlined rather broadly the more pertinent and important features of the present invention in order that the detailed description of the invention that follows may be better understood so that the present contribution to the art may be more fully appreciated. Additional features of the invention will be described hereinafter which form the subject of the claims of the invention. It is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention. Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

It is a general object of this invention to create an attractive door-side container to store footwear.

Another object of this invention is to create a hermetic door-side footwear container that has an internal tray with a removable insert tray to catch the debris that falls off the footwear.

An additional object of this invention is to create a door-side footwear container that has an internal tray with a removable insert tray having a grate on top on which to place the footwear, allowing air to circulate around them.

A further object of this invention is to create a door-side container to store footwear where the cover rotates back out of the way when opened.

Yet another object of this invention is to create a door-side container to store footwear where a tray automatically moves forward when the cover is opened.

Another object of this invention is to create a door-side container to store footwear with an incandescent light bulb to warm and dry footwear along with a transparent panel to furnish a night-light feature.

A further object of this invention is to create an alternate embodiment of the door-side container to store footwear with an electronic heater and fan to dry footwear.

Still further, an object of this invention is to create another alternate embodiment of the door-side footwear container with a foot pedal as a means to open the cover.

Another object of this invention is to create a door-side container to store footwear with a compartment for deodorizing products.

Yet another object of this invention is to create an attractive door-side container to store footwear that may be placed outdoors and which will keep footwear warm and dry.

A final object of this invention is to enhance the entry into homes and eliminate unsightly piles of footwear and the debris that falls off shoes and boots.

These together with other objects of the invention, along with the various features of novelty which characterize the invention, are pointed out with particularity in the claims annexed to and forming a part of this disclosure. For a better understanding of the invention, its operating advantages and the specific objects attained by its uses, reference should be made to the accompanying drawings and descriptive matter in which there are illustrated preferred embodiments of the invention.

### BRIEF DESCRIPTION OF THE DRAWINGS

The accompanying drawings, which are incorporated in and form a part of this specification, illustrate embodiments of the invention and together with the description, serve to explain the principles of this invention.

FIG. 1 depicts a perspective view of the basic Door-Side Footwear Container.

FIG. 2 depicts a perspective view of an alternate embodiment of the Door-Side Footwear Container with a transparent or opaque window.

FIG. 3 depicts a perspective view of the first alternate embodiment of the Door-Side Footwear Container with the cover open and the internal tray extended.

FIG. 4 depicts a perspective view of the second alternate embodiment of the Door-Side Footwear Container with the cover open and the internal tray extended displaying the insert tray removed and the grate elevated.

FIG. 5 depicts a front view of the basic Door-Side Footwear Container.

FIG. 6 depicts a cross section of the basic Door-Side Footwear Container with the cover closed.

FIG. 7 depicts a cross section of the basic Door-Side Footwear Container with the cover open, the internal tray extended, the insert tray elevated, and the grate further elevated.

FIG. 8 depicts a cross section of the second alternate embodiment of the Door-Side Footwear Container with the cover closed having a thermostatically controlled fan and heater and an electric motor activated by the means of a motion sensor.

FIG. 9 depicts a cross section of the second alternate embodiment of the Door-Side Footwear Container with the cover open having a thermostatically controlled fan and heater and an electric motor activated by the means of a motion sensor.

FIG. 10 depicts a cross section of the third alternate embodiment of the Door-Side Footwear Container with a foot pedal actuator to extend the internal tray.

For a fuller understanding of the nature and objects of the invention, reference should be had to the following detailed description taken in conjunction with the accompanying drawings which are incorporated in and form a part of this specification, illustrating embodiments of the invention and together with the description, serve to explain the principles of this invention.

### DETAILED DESCRIPTION OF THE PREFERRED EMBODIMENTS

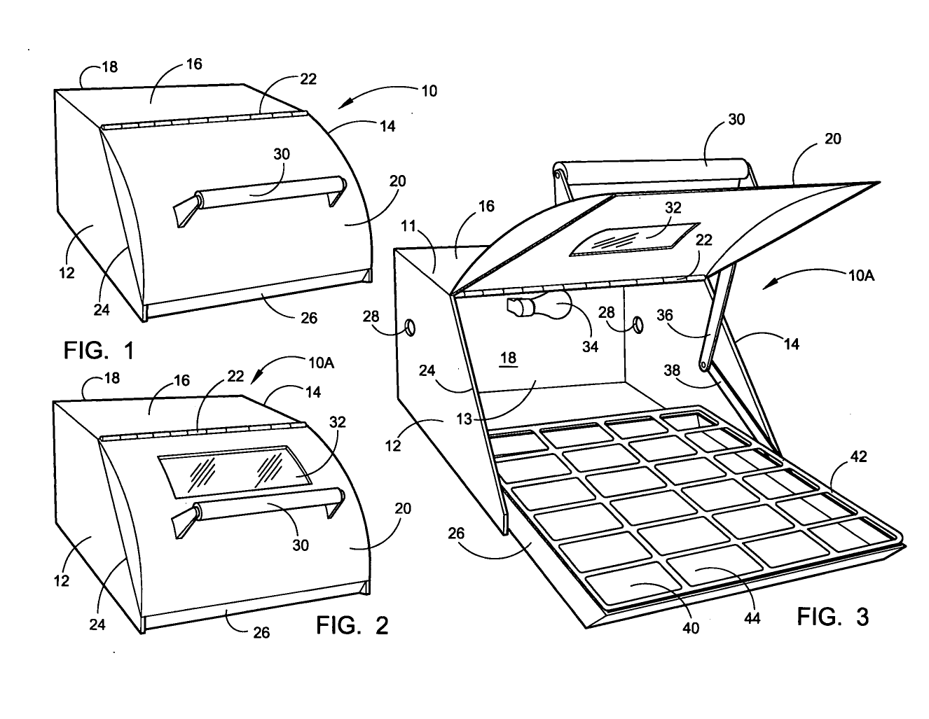

Referring now to the drawings, wherein similar parts of the invention are identified by like reference numerals, there is seen in FIG. 1 a perspective view of the basic Door-Side Footwear Container 10 having a housing 11 consisting of a left side panel 12, a right side panel 14, a top panel 16, and a back panel 18. The cover 20 is rotatably engaged to the housing using means for rotational engagement such as piano style of hinge 22 attached to the top panel 16. The cover 20 mounts on the Door-Side Footwear Container 10 on a bias angle 24 so that when it is opened it moves upward and out of the way thereby providing direct vertical access to the feet of the user trying to access the internal tray 26. The cover 20 is raised by the means of the handle 30 or other means for hand engagement.

FIG. 2 depicts a perspective view of another preferred mode of the Door-Side Footwear Container 10A consisting of a housing 11 formed of a left side panel 12, a right side panel 14, a top panel 16, and a back panel 18. The cover 20 is rotationally engaged for upward rotation using a piano style of hinge 22 attached to the top panel 16 or other means for rotational engagement. The cover 20 mounts on the Door-Side Footwear Container 10A on a bias angle 24 so that when it is opened it moves up and back to providing direct downward foot access to a frontal area the internal tray 26. The cover 20 is raised by the provision of a means for hand engagement such as the handle 30. A transparent or opaque window 32 communicates through the cover 20 or the top 16 or side panels 12 or 14, to thereby allow the light from the interior illumination means shown as incandescent light bulb 34 attached to the back panel 18 and illustrated in FIG. 3, to also be employed as a porch night-light. Further, when an incandescent light bulb 34 is employed as the means for illumination it provides a means for warming the interior of the housing 11 which is especially desirable in cold climates where footwear can freeze or become frigid or when used with ski boots which are more pliable and comfortable when warm.

FIG. 3 shows another preferred embodiment of the Door-Side Footwear Container 10A depicting the internal tray 26 and having means to translate the tray 26 out of the housing concurrently as the cover 20 is raised. One such means for translation is provided by fixed arms 36 attached to one or both sides of the cover 20 which communicate pressure on the linkage arms 38 attached to one or both sides of the internal tray 26. In use, when the cover 20 is raised by the user, the linkage arms 28 move in response to the fixed arms 36 movement induced by the opening of the cover 20 and act to translate the the internal tray 26 to the forward position shown in FIG. 3. Closing the cover 20 acts to translate the tray 26 back to a stored position inside the housing 11. Forward and rearward translation of the internal tray 26 can vary depending upon the location of the attachment points and the lengths of the fixed arms 36 and the linkage arms 38. In a particularly preferred mode of the device, ventilation holes 28 may be added to the device to allow venting of accumulated moisture within the housing 11. Also in a particularly preferred mode of the device, an insert tray 40 would be included that engaged for suspension above the internal tray 26 thereby allowing debris of footwear to fall through the grate 42 and collect in the insert tray cavity 44 of the insert tray 40, for easy removal and disposal. This is especially desirable when footwear is muddy or dirty such as ski boots or hiking boots in winter.

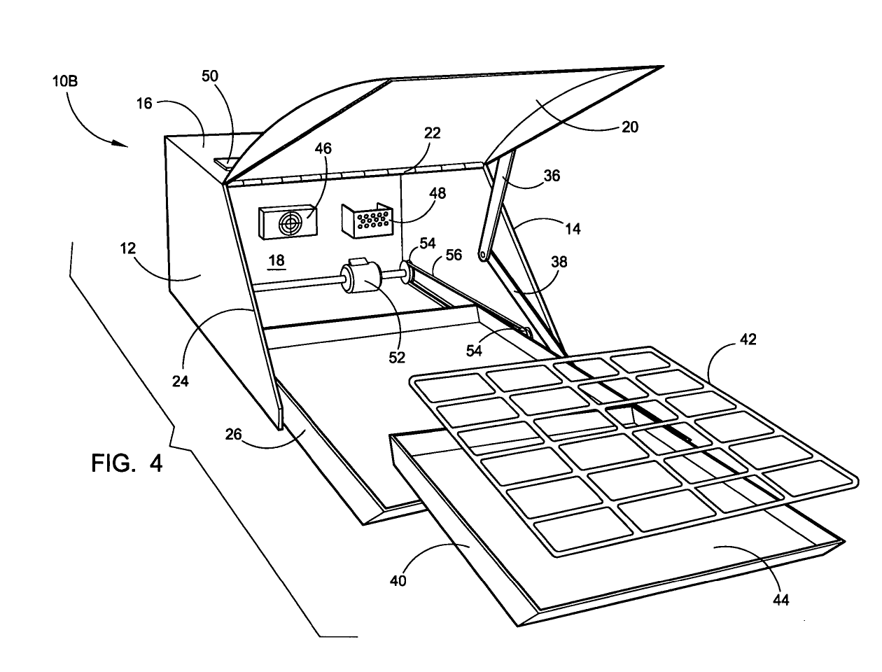

FIG. 4 depicts a perspective view of a particularly preferred mode of the device herein disclosed, showing the housing 11 formed of the left side panel 12, a right side panel 14, a top panel 16, and a back panel 18. Means for rotational engagement of the cover 20 is depicted by the piano style of hinge 22 attached to the top panel 16; however, those skilled in the art will realize other means for rotational engagement can be used and the mount need not be to the top panel 16 so long as the cover rotates up to allow direct access of the feet of the user to the interior cavity 13 of the housing 11. The cover 20 might also slide or rotate into the interior cavity 13 so long as it is relocated so that a user has a substantially unimpeded downward path with their foot to the tray for removal and reclaiming their footwear easily from a standing position.

As noted, the cover 20 is engaged to the Door-Side Footwear Container 10B such that it is on a bias angle 24 when in a closed position with its distal edge adjacent to the tray 26. The distal edge is opposite the engagement edge of the cover 20 near the hinge 22 or other means for rotational engagement to the housing 11. Once the cover is opened, it moves up and back to provide direct downward foot access to the internal tray 26 allowing the user to easily access or leave their footwear in the housing 11 in a downward motion.

Optionally, all modes of the device can include a thermostatically controlled fan and heater 46 along with a deodorizing compartment 48 attached to the back panel 18 or side panels to provide dehumidization of the interior cavity 13 and also to deodorize it by placing charcoal or other means for deodorizing a confined space. As shown in FIG. 4, opening of the cover 20 can also be automated with the inclusion of a motion sensor 50 attached to an exterior surface of the device such as the top panel 16, which activates a motor 52 to work the forward and rear pulleys 54 and the drive belt 56 which engaged to the tray 26 using a pin 19 or other means to connect the belt 56 to the tray 26 to thereby move the internal tray 26 out and lift the cover 20 by the means of the linkage arms 38 and the fixed arms 36. The insert tray 40 with the insert tray cavity 44 is shown raised above the internal tray 26 with the grate 42 further elevated. Using such a motor 52 operatively engaged to the tray 26 and cover 20 thereby provides the means to translate the tray to and from the forward position automatically and also a means for powered lifting and closure of the cover 20.

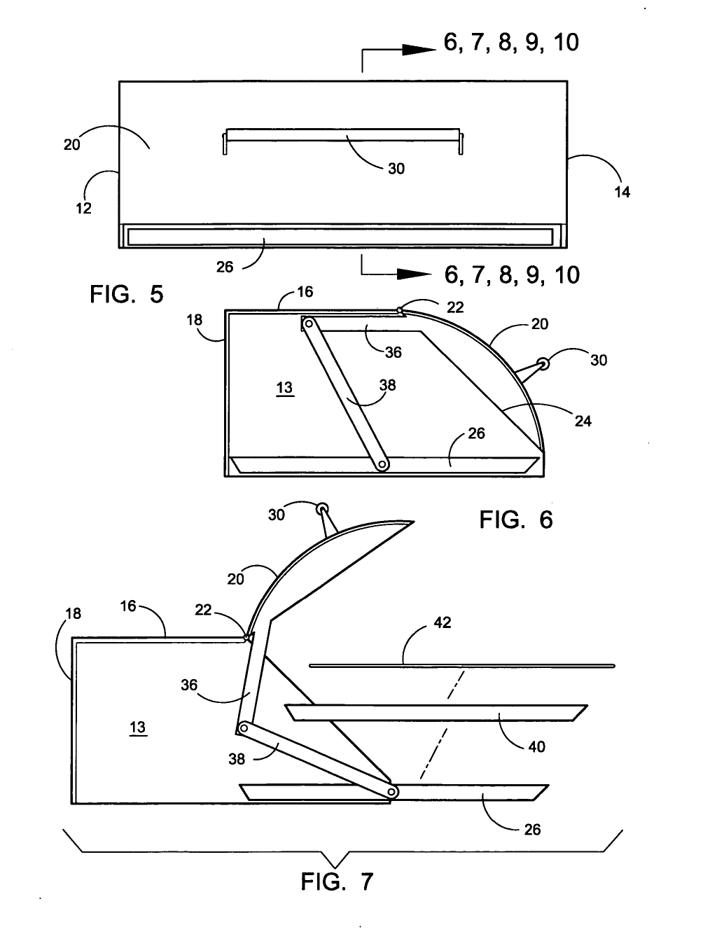

FIG. 5 depicts a front view of the basic Door-Side Footwear Container 10 showing the left side panel 12, the right side panel 14, the cover 20, the internal tray 26 and the handle 30. The drawing shows where the cross sections are taken for FIGS. 6,7,8,9, and 10.

FIG. 6 is the cross section of the basic Door-Side Footwear Container 10 illustrating the location of the internal tray 26, the fixed arm 36 and the linkage arm 38, when the cover 20 is in the closed position and the tray 26 translated to a retracted position inside the interior cavity 13.

FIG. 7 is the cross section of the basic Door-Side Footwear Container 10 illustrating the location of the internal tray 26, the fixed arm 36 and the linkage arm 38, when the cover 20 is in the open position with and exploded view of insert tray 40 and the grate 42 which is adapted for engagement elevated above the tray 40.

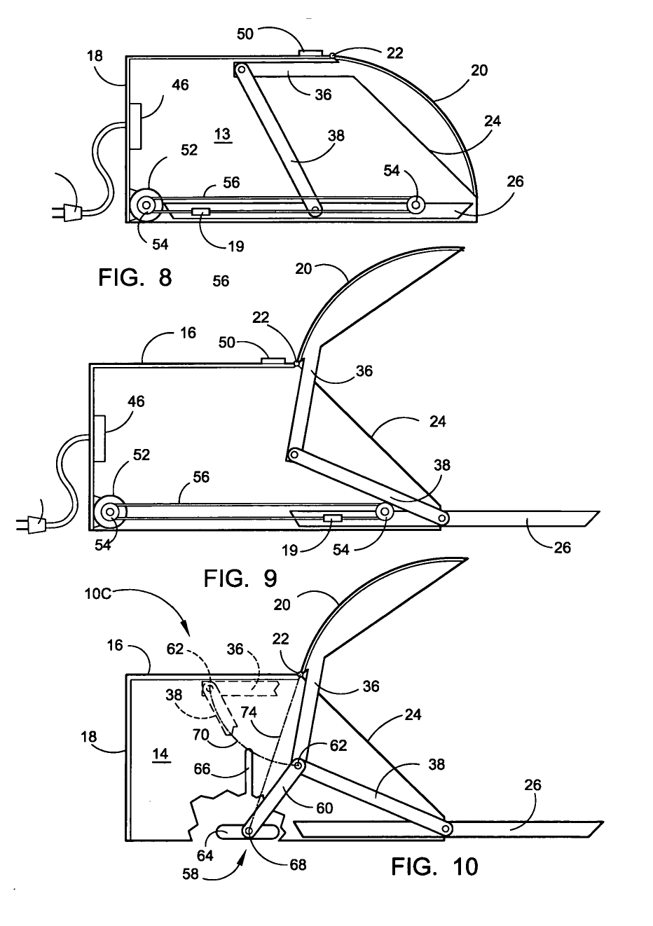

FIG. 8 depicts a cross section of the preferred mode of the Door-Side Footwear Container 10B with the cover 20 closed having the thermostatically controlled fan and heater 46 and an electric motor 52 activated by the means of a motion sensor 50. The electric cord 72 extends from the back panel 18.

FIG. 9 depicts a cross section of the second alternate embodiment of the Door-Side Footwear Container 10B with the cover 20 open and the tray 26 translated forward and having the thermostatically controlled fan and heater 46 and an electric motor 52 activated by the means of a motion sensor 50. The electric cord 72 extends from the back panel 18.

FIG. 10 depicts a cross section of the of the Door-Side Footwear Container 10C with a foot pedal actuator 58 providing both a means to translate the internal tray 26 and concurrently elevate the cover 20. The foot pedal actuator 58 consists of a second linkage arm 60 attached to the pivot point 62 of the fixed arm 36 and the linkage arm 38 where by pressing on the foot pedal 64 the cover 20 will be raised to the upright position along with moving the insert tray 26 forward. Clearance groove 66 in the right side panel 14 controls the position of the pedal shaft 68 when moving vertically in an up and down action. A unique feature in this mode of the device is that when the foot pedal 64 is depressed thus concurrently raising cover 20 to the open position and translating the tray 26 to the forward position, the linkage pivot point 62 passes over the center line 74 between the center of the piano hinge 22 and the center of the pedal shaft 68 thereby providing a means for locking the cover 20 in the upright position. This position is reversible to a closed position by depressing the foot pedal 64 a second time rotating the cover 20 closed and concurrently translating the tray 26 back to a retracted position inside the interior cavity 13. Fixed arm 36 and linkage arm 38 are shown in phantom to illustrate the arc 70 that the linkage arm 38 travels to reach the locked position.

The Door-Side Footwear Container shown in the drawings and described in detail herein discloses arrangements of elements of particular construction and configuration for illustrating preferred embodiments of structure and method of operation of the present invention. It is to be understood, however, that elements of different construction and configuration and other arrangements thereof other than those illustrated and described may be employed for providing a Door-Side Footwear Container in accordance with the spirit of this invention, and such changes, alternations and modifications as would occur to those skilled in the art are considered to be within the scope of this invention as broadly defined in the appended claims.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way

What is claimed is:

1. A footwear storage container comprising:
a housing;
said having a first sidewall, a second sidewall, a rear panel engaged between said first sidewall and second sidewall, a top panel extending to a distal edge forward from said rear panel along respective top side edges of said first sidewall and said second sidewall;
a bottom surface area opposite said top panel defined by the area between respective bottom edges of said first sidewall and said second sidewall and a bottom edge of said rear panel;
an interior cavity defined by the area between said first sidewall, said second sidewall, said top panel, said rear panel and said bottom surface area;
an aperture communicating with said internal cavity opposite said rear panel, said aperture defined by a front edge of said top panel and respective front edges of said first sidewall and said second sidewall and a forward edge of said bottom surface area;
a tray positioned adjacent to said bottom surface area of said interior cavity;
a cover, having an upper edge, and a lower edge connected by two side edges;
said cover having a closed position, substantially covering said aperture wherein said lower edge of said cover is adjacent to said forward edge of said bottom surface area;
said cover having an open position allowing communication to said internal cavity through said aperture;
means for engagement of said cover to said housing, said means for engagement allowing said cover to transition between said open position and said closed position;
said respective bottom edges of said first sidewall and second sidewall extending further from said rear panel then said respective top edges of said first sidewall and second sidewall, thereby defining a bottom surface area having a forward portion extending a distance further from said rearwall than said distal edge of said top surface, and defining said aperture at a bias angle; and
said forward portion of said bottom surface area between accessible to the foot of a standing user is a substantially downward motion of said foot when said cover is in said open position.

2. The footwear storage container of claim 1 additionally comprising:
means to grip said cover with the hand of said user and move it between said open position and said closed position.

3. The footwear storage container of claim 1 additionally comprising:
a tray positioned above said bottom surface area, said tray having stored position wherein a frontal area of said tray is situated in said forward portion of said bottom surface area.

4. The footwear storage container of claim 2 additionally comprising:
a tray positioned above said bottom surface area, said tray having stored position wherein a frontal area of said tray is situated in said forward portion of said bottom surface area.

5. The footwear storage container of claim 3 additionally comprising:
a grate removably suspended above a bottom surface of said tray.

6. The footwear storage container of claim 4 additionally comprising:
a grate removably suspended above a bottom surface of said tray.

7. The footwear storage container of claim 3 additionally comprising:
means to translate said tray between said stored position to projected position wherein said frontal area projects past said forward area of said bottom surface area.

8. The footwear storage container of claim 4 additionally comprising:
means to translate said tray between said stored position to projected position wherein said frontal area projects past said forward area of said bottom surface area.

9. The footwear storage container of claim 5 additionally comprising:
means to translate said tray between said stored position to projected position wherein said frontal area projects past said forward area of said bottom surface area.

10. The footwear storage container of claim 6 additionally comprising:
means to translate said tray between said stored position to projected position wherein said frontal area projects past said forward area of said bottom surface area.

11. The footwear storage container of claim 7 wherein said means to translate said tray is engaged to said cover whereby movement of said cover to said open position translates said tray to said projected position.

12. The footwear storage container of claim 8 wherein said means to translate said tray is engaged to said cover whereby movement of said cover to said open position translates said tray to said projected position.

13. The footwear storage container of claim 1 additionally comprising:
means for illumination of said interior cavity.

14. The footwear storage container of claim 13 additionally comprising:
a transparent portion in at least one of said top panel, said side panels, and said cover; and
said transparent portion providing a means to illuminate an area adjacent to said housing.

15. The footwear storage container of claim 3 additionally comprising:
means for illumination of said interior cavity.

16. The footwear storage container of claim 5 additionally comprising:
means for illumination of said interior cavity.

17. The footwear storage container of claim 8 additionally comprising:
means for illumination of said interior cavity.

18. The footwear storage container of claim 11 additionally comprising:
means for illumination of said interior cavity.

19. The footwear storage container of claim 18 additionally comprising:
a transparent portion in at least one of said top panel, said side panels, and said cover; and
said transparent portion providing a means to illuminate an area adjacent to said housing.

20. The footwear storage container of claim 19 additionally comprising:
means for heating said interior cavity.
